(19) United States
(12) Patent Application Publication
(10) Pub. No.: US 2026/0366210 A1
(43) Pub. Date: Nov. 19, 2026

(54) Forming Substrate with Highly Textured Surface

(71) Applicant: Kimberly-Clark Worldwide, Inc., Neenah, WI (US)

(72) Inventors: Walter G. Bauer, Neenah, WI (US); John P. David, Appleton, WI (US)

(21) Appl. No.: 19/138,715

(22) PCT Filed: Dec. 20, 2022
(86) PCT No.: PCT/US2022/053509

§ 371 Date: Jun. 13, 2025

(51) Int. Cl. D04H 1/435; B32B 3/30; B32B 5/02; B32B 5/26; B32B 27/12; B33Y 10/00; B33Y 80/00

(52) U.S. Cl. CPC D04H 1/435; B32B 3/30; B32B 5/022; B32B 5/266; B32B 27/12; B33Y 80/00; B32B 2262/0284; B33Y 10/00

(57) ABSTRACT

The present disclosure is generally directed to a forming substrate for producing highly textured nonwoven webs. The forming substrate includes a pattern of raised elements. Each raised element is formed from a plurality of layers. In accordance with the present disclosure, each raised element includes a base layer that has at least one dimension that is greater or longer than the same or a corresponding dimension on one or more height building layers that are deposited on top of the base layer. In this manner, the pattern of raised elements stay in registration with the base layer even if the underlying substrate undergoes dimensional changes during the process of producing the raised elements.

### BACKGROUND

Fibrous nonwoven web materials are in wide use in a number of applications including, but not limited to, absorbent structures and wiping products, many of which are disposable. In particular, such materials are commonly used in personal care absorbent articles such as diapers, diaper pants, training pants, feminine hygiene products, adult incontinence products, bandages, and wiping products such as baby and adult wet wipes. They are also commonly used in cleaning products such as wet and dry disposable wipes which may be treated with cleaning and other compounds which are designed to be used by hand or in conjunction with cleaning devices such as mops. Yet a further application is with beauty aids such as cleansing and make-up removal pads and wipes.

In many of these applications, three-dimensionality and increased surface area are desirable attributes and can be imparted via a variety of processes that texture or emboss the surface of the nonwoven web. Textures or decorative lines on nonwoven products may be achieved using patterned forming wires. However, as thicker, and more structured nonwoven products have become desirable, providing patterned forming wires capable of providing adequate surface texture has proven challenging.

In order to form nonwoven webs that have a highly textured surface, forming wires have been produced with larger pattern or element heights in order to improve surface texture of nonwoven products produced on the forming wire. In the relatively recent past, topographical patterns have been formed on the forming wire using additive manufacturing or three-dimensional printing. One problem that has been experienced, however, is being able to print a topographical pattern on a forming wire that is durable and will not degrade or wear away over time. Thus, in order to form raised pattern elements on the forming wire, polymers at high temperatures have been deposited onto a forming wire made from polymer filaments. In this manner, the heated polymer material deposited on the forming wire forms a strong bond with the polymer filaments in addition to impregnating the forming wire within void spaces and interstices. Exposing the forming wire to high temperature polymer materials, however, can cause the forming wire to undergo changes in length. For instance, the length of the forming wire may contract.

Although these changes in length of the forming wire are relatively minor on a local scale, the changes can cause the pattern being printed onto the forming wire to fall out of alignment, especially over greater lengths. Consequently, a need currently exists for a process and method of forming raised pattern elements on a forming wire using additive manufacturing while maintaining the pattern in alignment even if the forming wire were to undergo dimensional changes during the process.

### SUMMARY

In general, the present disclosure is directed to printing or depositing a multi-layer pattern on a forming substrate while the forming substrate undergoes dimensional irregularities. Through the process of the present disclosure, the forming substrate can change in length or width while the multi-layer pattern remains in alignment and registration. In accordance with the present disclosure, the pattern applied to the forming substrate includes a base layer or first layer that bonds to the forming substrate and becomes embedded into the weave of the fabric that forms the substrate. The base layer is provided with a sufficient size and dimension that allows for later layers to form on top of the base layer and stay in alignment and registration even if the forming substrate undergoes dimensional instability and/or changes in length or width.

In this regard, the present disclosure is directed to a forming substrate comprising a fabric. The forming substrate includes a top surface, a bottom surface opposite to the top surface, an x-y plane, and a thickness extending from the bottom surface to the top surface in a z-direction perpendicular to the x-y plane. The substrate is made from a plurality of filaments in a manner that forms voids between the filaments. The forming substrate further includes a pattern of raised elements positioned on the top surface of the substrate. The raised elements include at least two layers of a polymer material. More particularly, each raised element includes at least one base layer and at least one height building layer positioned on top of the at least one base layer. The base layer includes at least one dimension in the x-y plane that is greater than the same or corresponding dimension of the at least one height building layer. The at least one dimension, for instance, can be length, width, or diameter. The at least one dimension of the base layer can be greater than about 3%, such as greater than about 5%, such as greater than about 8%, such as greater than about 10%, such as greater than about 12%, such as greater than about 15%, such as greater than about 18%, such as greater than about 20%, such as greater than about 23%, such as greater than about 25%, such as greater than about 28%, such as greater than about 30%, and generally less than about 60%, such as less than about 40%, such as less than about 30% of the corresponding dimension on the at least one height building layer. In one aspect, each raised element can include a plurality of height building layers that generally have the same shape or alternatively form a tapered shape.

In one aspect, the pattern of raised elements can comprise a pattern of discrete shapes. Alternatively, the pattern can comprise a continuous pattern. In still another embodiment, the pattern can include a continuous pattern in combination with discrete shapes. For example, the pattern can include circles, ovals, triangles, crosses, squares, rectangles, diamond shapes, hexagons, other polygons, lines, swirls, stars, characters, emblems, or combinations thereof. The raised elements can generally have a height of at least about 0.1 mm, such as at least about 0.25 mm, such as at least about 0.5 mm, such as at least about 1 mm, such as at least about 1.5 mm, such as least about 2 mm, such as at least about 2.5 mm, such as at least about 3 mm, such as at least about 3.5 mm, such as at least about 4 mm, and generally less than about 10 mm, such as less than about 8 mm, such as less than about 7 mm.

In one aspect, the base layer can be longer than the at least one height building layer in the machine direction of the forming substrate. The base layer can be longer than the height building layer in more than one dimension, such as at least in two dimensions. In one aspect, the base layer can have the same shape as the height building layer but can have a larger surface area. In one aspect, the height building layers can be positioned off-center from the base layer during the process, especially when the forming substrate undergoes dimensional changes during three-dimensional printing.

The plurality of filaments contained within the forming substrate can be formed from a thermoplastic resin, a silicone rubber, or a non-silicone vulcanized rubber. The base layer of each raised element can be positioned directly adjacent to the top surface of the substrate, wherein the base layer encircles and/or is fused to one or more substrate filaments. In a further aspect, a melting point of the polymer material of the base layer differs from a melting point of the substrate by about 20% or less.

In one aspect, the substrate is polyethylene terephthalate. Additionally or alternatively, the polymer material used to form the raised elements can be a glycol modified polyethylene terephthalate. In a further aspect, the polymer material of the raised elements is disposed on the substrate via additive manufacturing, preferably wherein the polymer material is disposed on the substrate via a fused deposition modeling (FDM) process.

The present disclosure is also generally directed to a method of manufacturing a forming wire according to any one or more of the above aspects. The method includes: forming the continuous pattern of raised elements on the substrate by dispensing onto the top surface of the substrate a base material layer from an extrusion head transported in the x and/or y plane over the top surface of the substrate, where at least a portion of the voids are filled with the polymer material, and dispensing one or more additional height building layers of the polymer material onto the first polymer material layer until the pattern height is reached.

Furthermore, the present disclosure is also generally directed to a method of disposing a plurality of fibers on the forming wire to form a web and drying the web.

Other features and aspects of the present invention are set forth in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a fragmentary top plane view of a substrate of the present disclosure;

FIG. 2 is a cross-sectional view of a substrate of the present disclosure;

FIG. 3 is a cross-sectional view of a forming substrate including a raised element made in accordance with the present disclosure;

FIG. 4 is a cross-sectional view of a forming substrate illustrating another embodiment of a raised element in accordance with the present disclosure;

FIG. 5 is a perspective view of one embodiment of a forming substrate made in accordance with the present disclosure including a pattern of raised elements;

FIG. 6 is another perspective view of one embodiment of a forming substrate made in accordance with the present disclosure including a pattern of raised elements;

FIG. 7 is another perspective view of one embodiment of a forming substrate made in accordance with the present disclosure including a pattern of raised elements; and

FIG. 8 is a partial cross sectional view of the forming substrate illustrated in FIG. 7.

Repeat use of reference characters in the present specification and drawings is intended to represent the same or analogous features or elements of the present invention.

### DEFINITIONS

As used herein, the terms “about,” “approximately,” or “generally,” when used to modify a value, indicates that the value can be raised or lowered by 10%, such as, such as 7.5%, 5%, such as 4%, such as 3%, such as 2%, such as 1%, and remain within the disclosed aspect. Moreover, the term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example aspects, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material.

As used herein the term “Discrete” when referring to an element disposed on the surface of a tissue product, such as a line element, a design element or a pattern, means that the element is visually unconnected from other elements, does not share at least one connection point with one or more adjacent elements, and/or does not extend continuously in any dimension of the tissue product surface.

As used herein, the term “fabric” refers to cloth or paper products comprising a plurality of filaments and voids between the filaments. The fabric may be a woven or non-woven material, and may include papermaking/nonwoven forming fabric or products made from tissue webs (e.g., bath tissues, facial tissues, paper towels, wipes, (e.g., industrial, foodservice, or personal care wipes), napkins, medical pads, and the like). The fabric may be made from a variety of processes including, but not limited to, airlaid processes, wet-laid processes such as with cellulosic-based tissues or towels, hydroentangling processes, staple fiber carding and bonding, solution spinning, or an uncreped through air dried (UCTAD) process. The fabric may be made of a variety of materials, including natural fibers, synthetic fibers, or combinations thereof. As will be discussed in greater detail below, the terms “forming wire” and “forming fabric” may be used interchangeably herein.

As used herein “pattern” or “decorative pattern” refers to any non-random repeating design, figure, or motif. It is not necessary that the elements of the pattern form recognizable shapes, and a repeating design of the elements is considered to constitute a decorative pattern.

As used herein, the term “solid free form fabrication” (SFF) generally refers to the three-dimensional printing of material using any one of the well-known layer manufacturing processes, such as stereo lithography, selective laser sintering, inkjet printing, laminated object manufacturing, fused deposition modeling, laser-assisted welding or cladding, and shape deposition modeling. SFF typically involves representing a 3D object with a computer-aided design (CAD) geometry file, converting the design file into a machine control command, and using the command to drive and control a part-building tool for building parts essentially point-by-point or layer-by-layer.

As used herein, the term “additive manufacturing” refers to manufacturing techniques that form a three-dimensional object or element by adding layer-upon-layer of material. Additive manufacturing processes include solid free form fabrication and fused deposition modeling processes.

As used herein, the term “3D printed” generally refers to a fused deposition modeling process (hereinafter abbreviated to FDM) as described in U.S. Pat. No. 5,121,329, the contents of which are hereby incorporated by reference in a manner consistent with the present disclosure, and generally employs a heated nozzle to melt and extrude out a material. The build material is supplied into the nozzle in the form of a rod or filament.

The term “printing head” or “extrusion head”, used interchangeably herein, mean the entire device for the conveying, melting and application of a filament in an extrusion-based 3D printing process.

As used herein, the term “woven” generally refers to a structure formed from a plurality of interconnected filaments. Woven refers to structures comprising a plurality of filaments that have been interconnected by weaving two or more filaments together, such as by interlacing in a repeating pattern, as well as structures made of a multiplicity of helical coils or links of filaments such as wire-link belts disclosed, for example, in U.S. Pat. No. 5,334,440.

As used herein the term “nonwoven web” generally refers to a web having a structure of individual fibers or threads which are interlaid, but not in an identifiable manner as in a knitted fabric. Examples of suitable nonwoven fabrics or webs include, but are not limited to, meltblown webs, spunbond webs, bonded carded webs, airlaid webs, coform webs, hydraulically entangled webs, and so forth.

### DETAILED DESCRIPTION

It is to be understood by one of ordinary skill in the art that the present discussion is a description of exemplary aspects only and is not intended as limiting the broader aspects of the present disclosure.

The present disclosure is generally directed to a method and process for forming a pattern of raised elements on a forming substrate. The raised elements are formed on the surface of the substrate in a layer-by-layer manner. In one aspect, for instance, the pattern of raised elements can be formed on the top surface of the substrate using three-dimensional printing. The first layer or base layer applied to the top surface of the forming substrate should form a strong bond with the filaments of the substrate. If the base layer does not form a strong bond with the underlying forming substrate, the raised elements may have a tendency to wear off over time. In one embodiment, in order to form a strong bond between the base layer and the forming substrate, the forming substrate is made from polymer filaments and the base layer is made from a polymer material. The polymer material is applied to the forming substrate at a relatively high temperature, such as greater than about 200 °C, such as greater than about 250 °C, such as greater than about 270 °C, and generally less than about 300 °C, such as less than about 290 °C. Applying the base layer at a high temperature can cause the surface of the filaments to melt and form a bond with the polymer material. In addition, the polymer material, at a high temperature, can impregnate the forming substrate and not only bond to the filaments in the substrate but also fill in void spaces of the substrate, thus forming a strong and stable layer for producing the raised elements.

One problem that has been experienced, however, is that the forming substrate or fabric may undergo dimensional changes caused by the exposure to the high temperature polymer material or by other external forces. Applying the high temperature polymer material to the forming substrate to form the base layer, for instance, can cause changes in the length of the forming substrate and, in one embodiment, can cause the forming substrate to contract. These changes in the dimensions of the forming substrate, although small on the local scale, can have a detrimental impact on the ability to form a pattern of raised elements on the forming substrate over greater lengths. In particular, the dimensional changes of the forming substrate can cause the pattern of raised elements to fall out of alignment. If the later layers of the raised elements, for instance, are not in alignment with the base layers, the raised elements may not form a strong bond with the top surface of the forming substrate and may wear off or otherwise break off.

In order to address the above noted problems, the present disclosure is directed to a method of forming a pattern of raised elements on a forming substrate that may undergo dimensional changes, such as an unstable length. In accordance with the present disclosure, a base layer or first layer is applied to the forming substrate that has at least one dimension, such as a diameter or perimeter, that is larger than the other layers applied to the base layer to form the raised elements.

Expanding the size of the base layer in at least one dimension in relation to the top layers allows for the pattern to accommodate any changes or shifts in the length of the forming substrate. In this manner, intricate patterns of raised elements can be formed on the forming substrate while remaining durable.

All different types of patterns can be applied to forming substrates in accordance with the present disclosure. The pattern of raised elements, for instance, can be a pattern of discrete shapes or can be a continuous pattern, such as a grid-like pattern. In still another aspect, the pattern of raised elements can include discrete shapes combined with continuous elements.

Each of the raised elements formed on the forming surface can have any suitable shape. Examples of possible shapes for forming the pattern include, but are not limited to, circles, ovals, triangles, crosses, squares, rectangles, diamond shapes, hexagons, other polygons, lines, swirls, stars, characters, emblems, or the like, as well as combinations thereof.

In one aspect, the pattern can be formed on the substrate via additive manufacturing, and in particular, SFF, such as a fused deposition modeling (FDM) process. For instance, in one aspect, additive manufacturing can be utilized to fabricate three-dimensional (3D) elements on the substrate to form the pattern.

In one aspect, the use of additive manufacturing, such as FDM, in the production of patterned substrates having 3D elements or decorative patterns thereon, can include forming the polymeric base layer on the substrate prior to formation of additional layers of the pattern. In some aspects, the polymeric base layer can provide a platform for the addition of subsequent layers without damaging or otherwise compromising the strength of the substrate, and thus allows for more rapid printing of subsequent layer(s). In some aspects, the polymeric base layer can also improve the adherence of FDM 3D elements to the surface of a fabric substrate by providing a surface for adherence of subsequent layers. In accordance with the present disclosure, the size of the base layer is adjusted such that registration of the top layers on the base layer still occurs even if the forming fabric undergoes dimensional changes.

An initial layer of a polymer material is utilized to form a first layer or base layer of the pattern by dispensing onto a surface of the substrate a flowable polymer material from an extrusion head transported over a top surface of the substrate. The flowable polymer material is of a sufficiently low viscosity to allow the flowable polymer material to flow into void spaces present in the substrate.

More specifically, upon contact with the substrate, the flowable polymer material flows in and around the filaments that form the substrate and into the voids, where the flowable polymer material and extrusion head partially melt and/or soften the substrate itself. Thus, as the flowable polymer material and substrate cool, the flowable polymer material and substrate solidify together, allowing the flowable polymer material to take the shape of the voids and encircle the filaments in addition to fuse the first layer of flowable polymer material and the substrate together, to mechanically secure the first flowable polymer layer or base layer to the substrate. The additional flowable polymer layers that form the pattern may then be printed onto the substrate over the base layer.

In general, any suitable polymer material can be used to form the base layer of the raised elements. In one aspect, the polymer material used to form the base layer can differ from the melting point of the polymer material used to form the filaments of the forming substrate by about 20% or less, such as about 17.5% or less, such as about 15% or less, such as about 12.5% or less, such as about 10% or less, such as about 7.5% or less, such as about 5% or less, such as about 2.5% or less, or any ranges or values therebetween. Furthermore, in an aspect, the melting point of the flowable polymer material, the melting point of the substrate, or both, is about 350 °C or less, such as about 325 °C or less, such as about 300 °C or less, such as about 275 °C or less, such as about 250 °C or less, such as about 225 °C or less, such as ab out 150 °C or more, or any ranges or values therebetween. Namely, when the melting point of the flowable polymer material used to form the base layer, the melting point of the substrate, or both are selected according to the above, the extrusion head can adequately soften the flowable polymer material, the substrate, or both, providing a strong adhesion between the flowable polymer material and the substrate.

The forming substrate may be formed from any suitable material that includes a plurality of filaments and voids between the filaments. The substrate may be, for example, a woven or non-woven material. The substrate may be a single layer or contain multi-layer. Examples of suitable substrates are described in, for example, WO 2019/028052 and US 2018/0209096, which are herein incorporated by reference.

The filaments (also referred to herein as “fibers”) forming the substrate may be made from a variety of materials. For instance, the filaments can include a thermoplastic resin, a silicone rubber, or a non-silicone vulcanized rubber made from at least a majority by weight of fluoroelastomer having good heat and chemical resistance. Suitable thermoplastic resins which can be used include, but are not limited to, polyvinyl fluoride, polyvinylidene fluoride, polyvinyl chloride, polyethylene, polypropylene, polyethers, styrene-butadiene copolymers, polybutylenes, polyethylene (“PE”), polypropylene (“PP”), polyphenylene sulfide (“PPS”), polyimides, polyamides, polysulfones, polysulfides, cellulosic resins, polyarylate acrylics, polyarylsulfones, polyurethanes, epoxies, poly(amide-imides), copolyesters, polyethersulfones, polyetherimides, polyarylethers, and the like, as well as combinations and copolymers thereof. In other instances the substrate may comprise a silicone rubber. In still other instances the substrate may comprise a fluoroelastomer layer bonded to a silicone rubber layer. In one aspect, the substrate comprises polyphenylene sulfide. Nonetheless, in one aspect, the substrate is formed from a polyester, such as, in an aspect, polyethylene terephthalate (PET).

Regardless of the substrate material selected, the substrate includes voids between the filaments. To assist the flowable polymer material of the first layer in filling the voids, in certain aspects, it can be desirable for the voids in the substrate to have a diameter of at least 100 μm. In one aspect, the distance between the voids is about that of the extrusion width, or smaller.

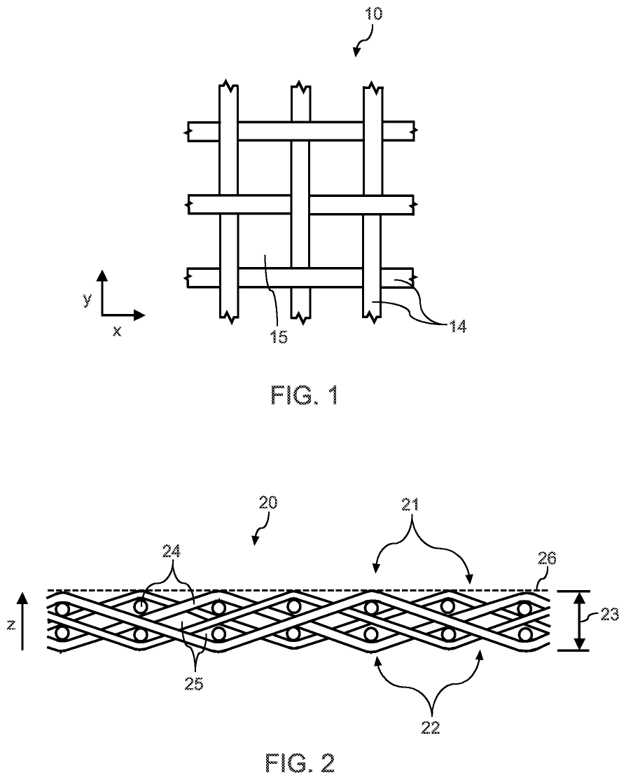

For instance, with reference to FIG. 1, depicted therein is a fragmentary top plane view of an exemplary forming substrate 10 (also referred to herein as a forming wire or fabric substrate). Substrate 10 is in an x-y plane and includes a plurality of filaments 14 and voids 15 between the filaments. In aspects where the substrate is a forming wire, the substrate 10 may have two principal dimensions—a machine direction (“MD”), which is the direction within the plane of the belt 10 parallel to the principal direction of travel of the fabric during manufacture and a cross-machine direction (“CD”), which is generally orthogonal to the machine direction. The substrate 10 is generally permeable to liquids and air. The substrate may be any fabric material comprising void spaces internal to or between the filaments forming the substrate. For instance, the substrate may be a woven or non-woven fabric. In one particularly preferred aspect the substrate is a woven fabric.

With reference to FIG. 2, depicted therein is a cross-sectional view of another exemplary substrate 20. Substrate 20 is in an x-y plane and has a top surface 21, a bottom surface opposite to the top surface 22, and a thickness 23 extending from the bottom surface to the top surface in a z-direction perpendicular to the x-y plane. Substrate 20 comprises a plurality of filaments 24 and voids 25 between the filaments. In one aspect, the substrate may be substantially planar, or may have a three-dimensional surface defined by ridges. As depicted in FIG. 2, in one aspect, the top surface 21 of substrate 20 has an uneven topography, with certain points of the filaments being higher than other points of the filaments. In one aspect, the substrate 20 may be constructed so that the highest points of the filaments 24 are substantially coplanar and form a top 26 of the substrate.

Although the substrates of the present disclosure are typically planar, the topography of the surfaces of the substrates may vary. This is illustrated, for example, in FIG. 2, which illustrates an exemplary substrate wherein the height to which filaments in the substrate extend in the z direction varies. In certain instances, it may be desirable to determine the highest point to which filaments in the substrate extend in the z direction (e.g., the highest point of the top surface), in order to ensure the extruder head is set at a sufficient height to produce a polymer material that extends above the top surface of the substrate. This point (i.e., the highest point of the top surface) is referred to herein as the “top” of the substrate.

Regardless of the substrate selected, the polymer material used to form the first pattern layer or base layer, additional pattern layers, or the entirety of the pattern (also referred to herein as “polymeric pattern material” or “polymer material”) can be any material that may be used in additive manufacturing processes, such as FDM. In particular, the polymer material may be any material that can melt to a flowable state and re-solidify in the voids in the substrate. Examples of suitable materials include thermoplastics, epoxies, other polymeric materials, and combinations thereof. In certain aspects the polymer material comprises a thermoplastic polymer such as, for example, a thermoplastic polymer comprising from about 0.5 and 10 weight percent silicone and a base polymer, such as a polyethersulfone, polyetherimide, polyphenylsulfone, polyphenylene, polycarbonate, high-impact polystyrene, polysulfone, polystyrenes, acrylic, amorphous polyamide, polyester, nylon, PEEK, PEAK and ABS.

Due to the microscale gaps, the polymer material may be a thermoplastic polymer having improved rigidity over silicone, nylons, ABS and the like. Thus, in an aspect, the polymer material is PET (polyester), PPS (polyphenylene sulfide), PCTA (poly 1,4 cyclohexane dimethylene terephthalate), PEN (polyethylene naphthalate), PVDF (polyvinylidene fluoride), PEEK (polyetheretherketone), derivatives therefore, and combinations thereof. In one particular aspect, the polymer material is a glycol modified polyester, such as, in an aspect, polyethylene terephthalate glycol (PETG).

Nonetheless, in one aspect, any polymer material having a sufficient rigidity may be used. For instance, a polymer material used herein can have a Shore A Hardness as measured according to ASTM D2240 of about 60 or greater, such as about 62.5 or greater, such as about 65 or greater, such as about 67.5 or greater, such as about 70 or greater, or any values or ranges therebetween.

Additionally or alternatively, the polymer material can have a Short D Hardness measured according to ASTM D2240 of about 50 or greater, such as about 52.5 or greater, such as about 55 or greater, such as about 57.5 or greater, such as about 60 or greater, or any values or ranges therebetween.

In one aspect, the substrate material and the polymer material should be selected to have substantial similarity in polymeric structure to provide a strong bond/adhesion between the first polymeric layer or base layer and the substrate. For instance, a PET substrate and a PETG first polymeric layer provide excellent bond strength due to the similarities in hydrophobicity and melt temperature. Thus, in one aspect, the substrate and polymer material may be selected from any one or more of the above listing of substrates and polymeric layers, but are also selected so as to have similar melting temperatures as discussed above, as well as being selected from similar classes of polymers so as to provide excellent adhesion between the substrate and the first polymeric layer.

In some aspects, the polymer material can also include various additives, such as carbon fibers, or other additives that improve processability or physical characteristics of the finished product. The polymer material can also include photo-curable and self-curing resins. Photocurable resins may include resins curable by UV curing, visible light curing, electron beam curing, gamma radiation curing, radiofrequency curing, microwave curing, infrared curing, or other known curing methods involving application of radiation to cure a resin. Suitable resins may also include those that may be cured via chemical reaction without the need for added radiation as in the curing of an epoxy resin, extrusion of an autocuring polymer such as polyurethane mixture, thermal curing, solidifying of an applied hotmelt or molten thermoplastic.

As discussed herein, the polymer material is dispensed onto the substrate in a flowable state. When in a flowable state, the polymer material is also referred to herein as the “flowable material” or the “flowable polymer material.” To obtain the flowable polymer material, the polymer material is heated to at least the melting point of the material prior to dispensing. The ability of the flowable polymer material to fill the voids in the substrate may be affected by the diameter of the voids in the substrate, and the viscosity of the flowable polymer material. In particular, it should be understood that the lower the viscosity of the flowable polymer material, the more readily the flowable polymer material will flow into voids in the substrate. In particular, lower viscosities are desirable when the void diameter or void volume is small. The flowable polymer material will thus preferably have a viscosity sufficiently low to penetrate voids in the substrate to a sufficient depth such that, upon cooling, a mechanical tension is generated. In one particular aspect, the flowable polymer material will desirably have a viscosity sufficiently low to allow the flowable polymer material to penetrate into the substrate to a depth of at least 50% of the thickness of the substrate.

The polymer material can be heated to any temperature at which the material is flowable, including to at least the melting point of the material. In certain aspects, it may be desirable to heat the polymer material to a temperature above its melting point. In particular, dispensing the polymer material onto the substrate at hotter temperatures allows the material to remain in a flowable state for longer periods of time, while minimizing the viscosity, which allows for easier filling of the voids in the substrate. Dispensing the polymer material onto the substrate at hot temperatures may also help maximize adhesion between the flowable polymer material and the filaments in the substrate as discussed above. Thus, in certain aspects, the polymer material may be heated to at least 10 °C, at least 20 °C, at least 30 °C, at least 40 °C, at least 50 °C, at least 60 °C, at least 70 °C, at least 80 °C, at least 90 °C, at least 100 °C, at least 150 °C, or at least 200 °C above the melting point of the material prior to dispensing as a flowable polymer material on the substrate.

It should be understood that it is also possible for a polymer material heated to a temperature above the melting/burning point of the substrate to be dispensed on the substrate without damaging the substrate itself. In particular, the heating capacity of the substrate may be affected by factors other than the temperature of the flowable polymer material and the melting/burning point of the substrate. For instance, the volume of polymer material extruded per linear distance travelled by the extrusion head (greater volume extruded increases the amount of heat applied to the substrate), filament size (thinner filaments in substrate decrease the heat capacity of the substrate), and print speed (slower printing may result in greater heat transfer from the heated extrusion head, which may melt/burn the fabric) may all affect substrate integrity and the amount of heat the substrate can absorb without damage. Thus, in other aspects, the polymer material may be heated to a temperature of at least the melting point of the polymer material, and also above the melting (or burning) point of the substrate.

When dispensing a polymer material onto the forming substrate at high temperatures, the forming substrate may, however, undergo dimensional changes, such as a contraction in length. As will be described in greater detail below, however, raised pattern elements are formed in accordance with the present disclosure that include a base layer having a surface area sufficient to account for any dimensional changes that the forming substrate may undergo.

As discussed herein, it is desirable to maximize the penetration of the flowable polymer material into the voids of the substrate. Thus, in one aspect, penetration of the flowable polymer material into the voids of the substrate may be facilitated by dispensing the flowable polymer material onto a heated substrate. By dispensing the flowable polymer material onto a heated substrate, the flowable polymer material does not cool as quickly, thus allowing a longer period of time for the flowable polymer material to penetrate and fill the voids of the substrate prior to solidifying.

Thus, in another aspect, the methods of the present disclosure may further comprise heating the substrate prior to forming the polymer material layer(s). The substrate may be heated to any temperature at which the substrate is not damaged (e.g., melted or otherwise degraded). In one aspect, the substrate is heated to a temperature of at least 70 °C, or at least 80 °C, at least 90 °C, at least 100 °C, at least 110 °C, at least 120 °C, at least 130 °C, at least 140 °C, at least 150 °C, at least 180 °C, at least 200 °C, at least 220 °C, at least 250 °C, or at least 270 °C. In one aspect, the substrate is heated to a temperature below the melting point of the substrate, including 1 °C, 2 °C, 5 °C, 10 °C, 15 °C, 20 °C, 30 °C, 40 °C, 50 °C, 60 °C, 70 °C, 80 °C, 90 °C, or 100 °C below the melting point of the substrate. The substrate may be heated using any suitable means known in the art for heating of fabric substrates. In one aspect, the substrate is placed on a supporting plate or belt during formation of the 3D elements, and is heated by heating the plate or belt to the desired temperature. In one aspect, the flowable polymer material is not subjected to a cooling step following dispensing on the substrate, but instead is allowed to solidify at ambient temperatures. Thus, in another aspect, the extrusion head does not contact the top surface of the substrate when forming the polymeric layers.

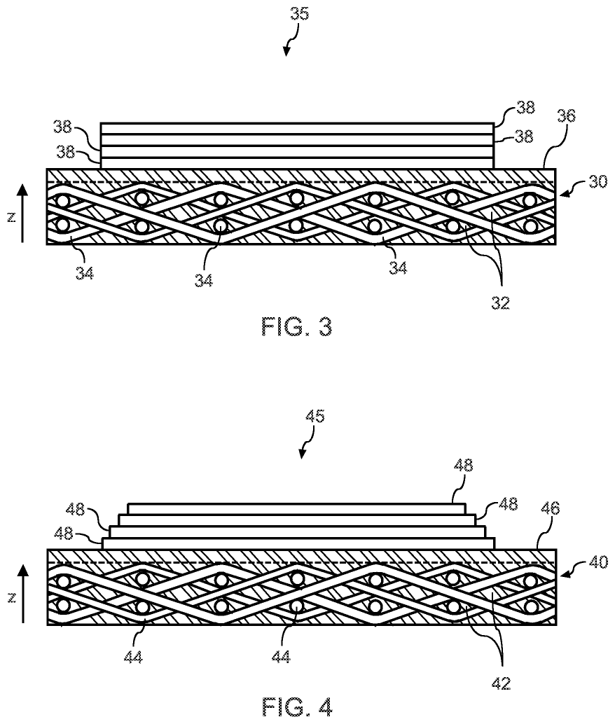

Referring to FIG. 3, one embodiment of a forming substrate 30 made in accordance with the present disclosure is shown. The forming substrate 30, in this embodiment, is comprised of a woven fabric made from polymer filaments 34. The fabric is woven so as to form voids 32 within the forming substrate 30.

In accordance with the present disclosure, a pattern of raised elements 35 are formed on the top surface of the forming substrate 30. The raised element 35 is formed on the substrate 30 in a layer-by-layer manner. The raised element 35 includes at least one base layer 36 that is adjacent to and in contact with the top surface of the substrate 30. On top of the base layer 36 are a plurality of height building layers 38.

As described above, the base layer 36 is formed at a high temperature in a manner such that the polymer material of the base layer 36 fills the voids 32 in the substrate 30 and surrounds the filaments 34 of the substrate. The polymer material of the base layer 36 extends in a z-direction into the substrate 30 and above the top of the substrate 30.

Establishing a good bond between the base layer 36 and the substrate 30 allows for the height building layers 38 to be later applied to the substrate with the durability needed during use, such as during the production of nonwoven webs. Applying the base layer 36 at a high temperature, however, can cause dimensional changes within the substrate 30, especially in the length direction. In particular, the length of the substrate 30 can contract on a localized scale. Thus, in accordance with the present disclosure, as shown in FIG. 3, the base layer 36 has at least one dimension that is greater than the same or corresponding dimension of the height building layers 38. For example, in one aspect, the base layer 36 can have a length that is greater than the length of the height building layers 38. Alternatively, the base layer 36 can have a perimeter or circumference that is greater than the perimeter or circumference of the height building layers 38.

In accordance with the present disclosure, the at least one dimension of the base layer 36 is at least about 3%, such as greater than about 5%, such as greater than about 8%, such as greater than about 10%, such as greater than about 12%, such as greater than about 15%, such as greater than about 18%, such as greater than about 20%, such as greater than about 23%, such as greater than about 25%, such as greater than about 28%, such as greater than about 30% of the same or corresponding dimension of the height building layers 38. The at least one dimension is generally less than about 60%, such as less than about 50%, such as less than about 40%, such as less than about 35% greater than the same or corresponding dimension of the height building layers 38.

In the embodiment illustrated in FIG. 3, the raised element 35 includes four height building layers. It should be understood, however, that the raised element 35 can include at least one and up to about 20 height building layers 38. For instance, the raised element 35 can include at least two, such as at least three, such as at least four, such as at least five, such as at least six height building layers 38.

The raised element 35 is for imparting texture into a nonwoven web made on the forming substrate 30. In this regard, the raised element 35 can extend from the top surface of the forming substrate 30 in an amount greater than about 0.1 mm, such as greater than about 0.25 mm, such as greater than about 0.5 mm, such as greater than about 1 mm, such as greater than about 1.5 mm, such as greater than about 2 mm, such as greater than about 2.5 mm, such as greater than about 3 mm, such as greater than about 3.5 mm, such as greater than about 4 mm, such as greater than about 4.5 mm, and generally less than about 10 mm, such as less than about 9 mm, such as less than about 8 mm, such as less than about 7 mm, such as less than about 6 mm, such as less than about 5 mm.

In the embodiment illustrated in FIG. 3, the height building layers 38 all have the same circumference or perimeter. During three-dimensional printing, registration is established after the base layer 36 is applied for forming the raised element 35. Due to the dimensional instability of the forming substrate 30, the height building layers 38 may be positioned on the base layer off-center.

The size of the base layer 36, however, ensures that the entire perimeter or circumference of the height building layers 38 stay within the perimeter or circumference of the base layer 36.

Referring to FIG. 4, another embodiment of a forming substrate made in accordance with the present disclosure including a pattern of raised elements 45 is shown. A forming substrate 40 is illustrated made from polymer filaments 42 that form voids 44. A base layer 46 is applied to the top surface of the substrate 40 in accordance with the present disclosure that fills the voids 42 and surrounds the filaments 44. After the base layer 46 is established, a plurality of height building layers 48 are then applied to a top surface of the base layer 46. As shown, the base layer 46 includes at least one dimension that is greater in size than the same or corresponding dimension of the height building layers 48 for ensuring that the height building layers 48 stay in registration with the base layer 46.

In the embodiment illustrated in FIG. 4, at least one dimension of the height building layers 48 is smaller with each layer causing a tapered effect. In this manner, the raised element 45 can be in the form of a pin, cone, or any shape having tapered sides.

In order to form the pattern of raised elements on the forming substrate as shown in FIGS. 3 and 4, additive manufacturing may be used. For instance, in one aspect, a substrate formed from a plurality of filaments and voids between the filaments, and having a top (i.e., extrusion head facing) surface, a bottom surface opposite to the top surface, an x-y plane, and a thickness extending from the bottom surface to the top surface in a z-direction perpendicular to the x-y plane, can be contacted with a first polymer material by dispensing onto the top surface of the substrate a flowable polymer material from an extrusion head transported in the x and/or y directions over the top surface of the substrate. Further, as discussed above, at least a portion of the voids are filled with the flowable polymer material. In addition, after formation of the first polymer material or base layer, at least one additional polymer material layer is formed on the substrate by incrementally transporting the extrusion head in the z direction away from the top surface of the substrate, wherein at least a portion of the at least one additional layer contacts the first polymer layer or base layer. Moreover, the process is repeated until the pattern height discussed above is achieved.

In one aspect, it can be beneficial to determine a spatial relationship between the substrate (fabric) and the extruder head. More particularly, identifying a top of the substrate (i.e., the highest point to which filaments in the substrate extend in the z direction). The top of the substrate can be identified by i) transporting the extrusion head over the top surface of the substrate in the x-y plane without contacting the substrate; and ii) while transporting the extrusion head over the top surface of the substrate, incrementally lowering the extrusion head in the z direction towards the top surface of the substrate until the filaments of the substrate begin to degrade (e.g., melt or otherwise show damage or degradation). In one aspect, the extrusion head is transported over the top surface of the substrate without dispensing polymer material. The extrusion head may be lowered towards the top surface of the substrate in any suitable increment. In one aspect, the extrusion head may be lowered towards the top surface of the substrate in increments of 60 μm, 50 μm, 40 μm, 30 μm, 20 μm, 10 μm, 5 μm, 3 μm, 2 μm, or 1 μm until contact with the filaments is observed.

Once the top of the substrate is determined, the extrusion head may be set at a height above the top of the substrate prior to forming the first polymeric material layer. As discussed herein, this ensures the polymer material extends above the top surface of the substrate. The height of the extrusion head above the top of the substrate may vary. In certain aspects, the height of the extrusion head is at least 0.01 mm, at least 0.05 mm, at least 0.07 mm, at least 0.1 mm, at least 0.15 mm, at least 0.17 mm, at least 0.2 mm, at least 0.25 mm, at least 0.27 mm, or at least 0.3 mm above the top of the substrate. In one particular aspect, the height of the extrusion head is set to 0.2 mm above the top of the substrate.

Once the extruder head height has been selected, the maximum volumetric flow rate for the extruder at the selected height can be calculated. Maximum volumetric flow rate may be determined by the following process:
1) Set up the printer/extruder with the desired substrate and extrusion head set to the desired height.
2) Print a series of about 50 mm lines with a constant volume of extruded material per linear distance traveled (cm³/cm), while increasing the travel speeds starting at a slow speed and incrementally increasing the speed (e.g., 600, 700, 800, 900, 1000, 1100, 1200, 1300, 1400, up to 1500 mm/min or higher).
3) Visually determine the highest speed that generates consistent extrusion.
4) Calculate maximum volumetric flow rate by multiplying the travel speed of the extrusion head by the volume of extruded material per linear distance traveled.

In one aspect, the maximum volumetric flow rate for the extruder may be from about 0.01 to about 0.02cm³/second.

Once the maximum volumetric flow rate is determined, the extrusion volume (e.g., volume of polymer material) dispensed onto the substrate per distance travelled by the extrusion head (“volume per linear distance”) can be determined. The extrusion volume per linear distance travelled by the extruder head needed to achieve adequate adhesion of the polymer material may be determined using the following procedure:
1) Print a series of patterns that exhibit 2 dimensional characteristics (e.g., circles, squares, or some other non-linear shape) onto the substrate. This allows adherence of the polymer material to be tested in different directions of printing. Print each set of patterns with a different cm³/cm value at the appropriate speed needed to maintain the calculated maximum volumetric flow rate at the selected extruder head height.
2) Subject the patterns to a platform adhesion test. This test may include, for example, bending the fabric at a severe radius, and mechanically attempting to pry the polymer material from the substrate.

An extrusion volume (e.g., volume of polymer material) per distance travelled by the extrusion head (cm³/cm) that balances the desired print speed and quality may then be chosen. Appropriate extrusion volume per distance travelled by the extrusion head may vary widely, depending on the extruder used and ultimate design of the 3D elements to be printed. In one aspect, the volume per distance may be from about 0.02 to about 0.2 cm³/cm.

The maximum linear speed at which the printer/extruder operates may be determined from the maximum volumetric flow rate at the selected height and the volume per linear distance. In certain aspects, the polymer material layer(s) is formed by transporting the extrusion head at a linear speed of from about 4 to about 40 mm/sec.

As discussed above, the polymer material is formed in a pattern over the surface area of the substrate. For example, the polymer material is applied at discrete locations according to the pattern selected. In such aspects, because the polymer material is only present at certain locations on the substrate, some of the voids in the substrate remain open (i.e., at locations where the polymer material is not present), which allows for increased air permeability through the finished forming wire. In such aspects, the polymer material forming the pattern (containing the 3D elements) is adhered to the substrate at discrete locations, while still allowing for air permeability through the fabric.

Based upon the desired pattern height, additional layer(s) as described herein may be utilized, and can be a single layer, or more typically, multiple layers of FDM printed layers which form the pattern on the fabric. The additional layer(s) are formed on the substrate by transporting the extrusion head in the x and/or y direction over the top surface of the substrate to form the desired pattern, while dispensing an additional flowable material. Elevation is provided to the 3D elements by incrementally transporting the extrusion head in the z direction away from the top surface of the substrate. The material used to form the additional layer(s) may be the same or different than the polymer material used to form the base layer. In one aspect, the additional layer(s) and polymer material are formed from the same material. In one aspect, the additional layer(s) and polymer material are formed from the same material and the extrusion head used to form the base layer is also used to form the additional layer(s). In certain aspects the pattern is formed by extruding, such as that disclosed in U.S. Pat. No. 5,939,008, the contents of which are incorporated herein by reference, or printing, such as that disclosed in U.S. Pat. No. 5,204,055, the contents of which are incorporated herein by reference, a polymer material onto the substrate. In other aspects the 3D element(s) may be produced, at least in some regions, by extruding or printing two or more polymer materials.

In one aspect the pattern or pattern element(s) are formed using SFF or layer manufacturing (LM) techniques, such as 3D printing techniques described in U.S. Pat. No. 5,204,055. Generally, 3D printing techniques may be employed to form an element from a series of layers of material with each layer printed and formed on top of the previous layer.

Three-dimensional printing of the elements generally begins with creating a computer model of the element in three dimensions using a suitable computer modeling program known in the art. The computer model of the element is completely sectioned into a series of horizontal digital slices to define a set of slice patterns for each layer.

In one aspect the pattern is formed using one or more printheads that span at least a portion of the width of the substrate. The printheads (also referred to herein as extrusion heads) may be moveable so as to print materials onto a static substrate, or the substrate may be moved and the printheads may be fixed. Regardless, it is generally preferred that the moving object be moved at a substantially constant speed in a flat plane. In one particularly preferred aspect a plurality of printheads extend across the width of the belt, which is moved in a flat plane during printing, perpendicular to the direction of travel of the substrate and are, preferably, spaced along the substrate with substantially constant separations. However, constant separation of the printheads is not critical.

The printheads print one layer of an element onto the previously printed layer. Thus the first printhead prints the first layer, the second printhead prints a second layer onto the first layer and the Nth printhead prints an Nth layer onto the (n-1)th layer. The printhead used to print the additional layers may be the same or different than what is used to dispense the polymer material. In one aspect, the printhead used to print the additional layer(s) is the same as the printhead used to dispense the polymer material.

The layers are of a constant thickness and the printheads are controlled so that, in plan view, layers are printed on top of each other. The distance from each of the printheads to the surface upon which they print is also preferably the same for all printheads. Thus, the distance from the first printhead to the substrate is preferably the same as the distance from the seventh printhead to the sixth layer. This may be achieved by sequentially raising the printhead(s) for each layer by the voxel height. In this situation, droplets ejected by printheads for different layers at exactly the same time will arrive at their destinations at the same time.

The materials printed by the printheads (and used to form the additional layer(s)) may include photo-curable and self-curing resins. Photocurable resins may include resins curable by UV curing, visible light curing, electron beam curing, gamma radiation curing, radiofrequency curing, microwave curing, infrared curing, or other known curing methods involving application of radiation to cure a resin. Suitable resins may also include those that may be cured via chemical reaction without the need for added radiation as in the curing of an epoxy resin, extrusion of an autocuring polymer such as polyurethane mixture, thermal curing, solidifying of an applied hotmelt or molten thermoplastic.

In one aspect, the polymer material layer(s) are formed by an LM method comprising an extrusion head that extrudes heated, flowable modeling material from a nozzle onto the substrate. The extruded material is deposited layer-by-layer in areas defined from a CAD model, as the extrusion head and the substrate are moved relative to each other in three dimensions by an x-y-z gantry system. The material solidifies after it is deposited to form a three-dimensional element. The material may be a thermoplastic material which solidifies after deposition by cooling. The polymer material is deposited in areas defined from a CAD model along the lines discussed herein. Namely, the CAD model or Solidworks model contains a pattern discussed above in which the base layer is larger than the top layers.

Extrusion heads and systems suitable for preparing three-dimensional elements as described above are commercially available from Stratasys® modeling machines. The extrusion head, which includes a liquefier and a dispensing nozzle, receives modeling material in a solid form. The filament is heated to a flowable temperature inside the liquefier and it is then dispensed through the nozzle. Thermoplastic materials have been found particularly suitable for deposition modeling in the Stratasys® modeling machines. A controller controls movement of the extrusion head in a horizontal x, y plane, controls movement of the build platform in a vertical z-direction, and controls the feeding of modeling material into the head. By controlling these processing variables, the modeling material is deposited at a desired flow rate in “beads” or “roads” layer-by-layer in areas defined from the CAD model to create a three-dimensional object that resembles the CAD model. The modeling material thermally solidifies, and the finished model is removed from the substrate.

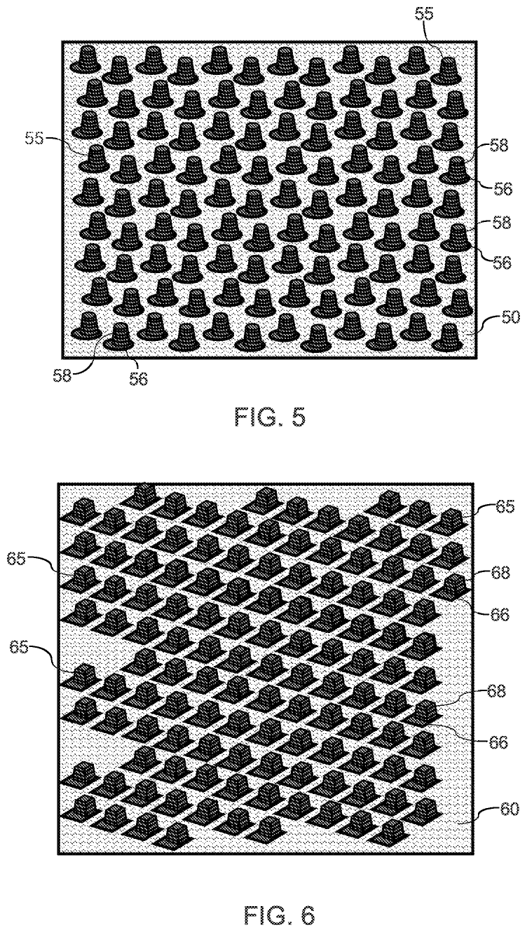

Referring now to FIGS. 5-8, various embodiments of forming substrates made in accordance with the present disclosure are shown. FIG. 5, for instance, illustrates a forming substrate 50 including a pattern of raised elements 55 made in accordance with the present disclosure. In this embodiment, the pattern of raised elements comprises a pattern of discrete shapes or cylinders that extend from the top surface of the substrate 50. As shown, each raised element 55 includes a base layer 56 that has a greater circumference than the height building layers 58 that form the cylindrical shapes. As shown, the height building layers 58 are generally off-center to the base layer 56.

Referring to FIG. 6, another embodiment of a forming substrate 60 made in accordance with the present disclosure is shown. In this embodiment, the forming substrate 60 includes a pattern of polygon shapes or raised elements 65. Each raised element 65 includes a base layer 66 and a plurality of height building layers 68. The base layer 66 has a larger perimeter than the height building layers 68.

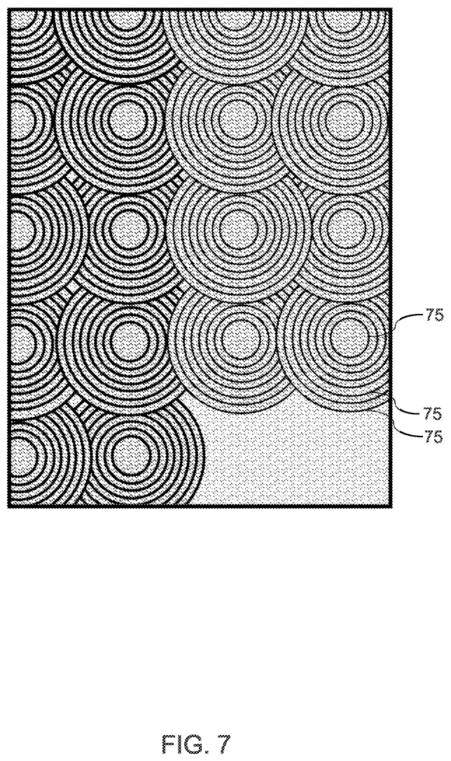

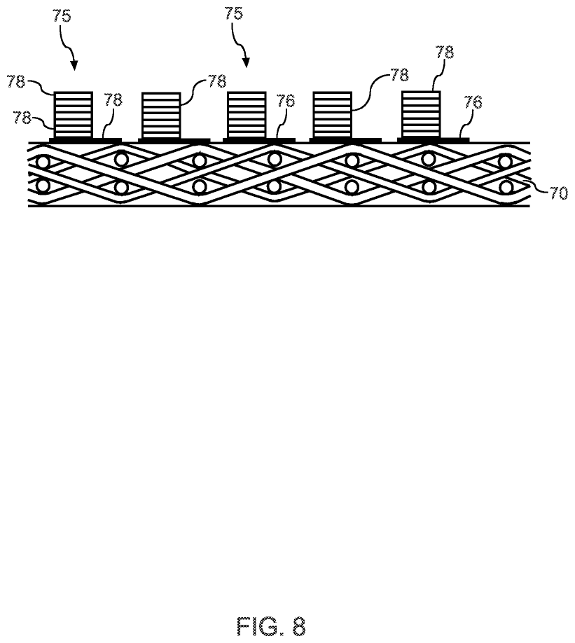

Still another embodiment of a forming substrate 70 made in accordance with the present disclosure is shown in FIG. 7 and FIG. 8. In this embodiment, the raised elements 75 have a circular or swirl-like design. As shown in FIG. 8, each raised element 75 includes a base layer 76 and one or more height building layers 78. As shown, the base layer 76 has a greater perimeter than the height building layers 78.

The forming substrate of the present disclosure is well suited for forming nonwoven webs and articles therefrom. Products such as wipes, absorbent articles, personal care articles, and the like can benefit from forming wires discussed herein with increased pattern height.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A forming substrate for nonwoven materials comprising:
a substrate having a top surface, a bottom surface opposite to the top surface, an x-y plane, and a thickness extending from the bottom surface to the top surface in a z-direction perpendicular to the x-y plane, the substrate comprising a plurality of filaments and voids between the filaments;
a pattern including at least one raised element on the top surface of the substrate, the raised element comprising at least two layers of a polymer material comprising at least one base layer and at least one height building layer, and wherein the base layer includes at least one dimension in the x-y plane that is greater than the same dimension of the height building layer.

2. A forming substrate as defined in claim 1, wherein the at least one dimension is length, width, or diameter.

3. A forming substrate as defined in claim 1, wherein the at least one dimension of the base layer is greater than about 5% than the same dimension of the height building layer and is less than about 50% than the same dimension of the height building layer.

4. A forming substrate as defined in claim 1, wherein the raised element has a height of at least about 0.1 mm and less than about 10 mm.

5. A forming substrate as defined in claim 1, wherein the pattern of at least one raised element comprises a pattern of discrete shapes.

6. A forming substrate as defined in claim 1, wherein the pattern of at least one raised element comprises a continuous pattern.

7. A forming substrate as defined in claim 1, wherein the at least one dimension of the base layer is in a machine direction of the substrate.

8. A forming substrate as defined in claim 1, wherein the base layer includes at least two dimensions in the x-y plane that are greater than the same dimensions of the height building layer.

9. A forming substrate as defined in claim 1, wherein the base layer has the same shape as the height building layer but is larger in the x-y plane.

10. A forming substrate as defined in claim 1, wherein a length of the substrate has changed after the pattern of at least one raised element has been applied to the top surface of the substrate.

11. A forming substrate as defined in claim 10, wherein the length of the substrate has contracted after the pattern of the at least one raised element has been applied to the top surface of the substrate.

12. A forming substrate as defined in claim 1, wherein the height building layer is positioned off-center in relation to the base layer on the raised element.

13. A forming substrate as defined in claim 1, wherein the top surface of the substrate has a surface area and wherein the pattern of at least one raised element occupies from about 10% to about 60% of the surface area of the top surface.

14. A forming substrate as defined in claim 1, wherein the pattern of at least one raised element comprises circles, ovals, triangles, crosses, squares, rectangles, diamond shapes, hexagons, other polygons, lines, swirls, stars, characters, emblems, or combinations thereof.

15. A forming substrate as defined in claim 1, wherein the plurality of filaments of the substrate are formed from a thermoplastic resin, a silicone rubber, or a non-silicone vulcanized rubber.

16. A forming substrate as defined in claim 1, wherein the base layer of each raised element is positioned directly adjacent to the top surface of the substrate, and wherein the polymer material of the base layer encircles and/or is fused to one or more substrate filaments.

17. A forming substrate as defined in claim 1, wherein the polymer material of the base layer has a melting point that differs from a melting point of the substrate by about 20% or less.

18. A forming substrate as defined in claim 1, wherein the filaments of the substrate comprise polyethylene terephthalate.

19. A forming substrate as defined in claim 1, wherein the polymer material of the at least one raised element comprises a glycol modified polyethylene terephthalate.

20. A forming substrate as defined in claim 1, wherein the polymer material of the at least one raised element has been disposed on the substrate via additive manufacturing, and wherein the polymer material is disposed on the substrate via a fused deposition modeling process.

21. A method of manufacturing a forming wire according to claim 1, the method comprising:
forming the pattern of the at least one raised element on the substrate by dispensing onto the top surface of the substrate the base layer from an extrusion head transported in the x and/or y plane over the top surface of the substrate, and wherein at least a portion of the voids are filled with the polymer material; and
dispensing one or more additional layers of the polymer material onto the base layer to form the one or more height building layers until a pattern height is reached.

22. A method of forming a nonwoven web comprising:
placing a fibrous material onto the forming substrate of claim 1 and forming a web from the fibrous materials.
